(19) United States
(12) Patent Application Publication
(10) Pub. No.: US 2003/0156792 A1
(43) Pub. Date: Aug. 21, 2003

(54) Optical waveguide amplifier using a circulator and an optical signal reflective surface and method employing same

(76) Inventors: Brian L. Lawrence, Clifton Park, NY (US); Russell Fuerst, Niskayuna, NY (US); Thomas Maney, Albany, NY (US); Andrew Shapiro, Schenectady, NY (US); Lawrence Clow, Waterford, NY (US); Mark Mendrick, Albany, NY (US); Charles Mack, Colonie, NY (US); Mark Cheverton, Mechanicville, NY (US)

Correspondence Address: Brett M. Hutton, Esq., HESLIN ROTHENBERG FARLEY & MESITI P.C., 5 Columbia Circle, Albany, NY, 12203, US

(21) Appl. No.: 10/080,141

(22) Filed: Feb. 21, 2002

(51) Int. Cl. G02B 6/26; H04B 10/17

(52) U.S. Cl. 385/39; 385/27; 359/341.3

(57) ABSTRACT

An optical amplifier with integrated optical waveguide, pump source and other, optional components for amplifying an input optical signal. The amplifier includes a circulator and an optical signal reflective surface disposed at an end opposite an optical signal input receiving end of the waveguide which enables an optical signal to pass through the waveguide a second time exposing the optical signal to further amplification. The disclosed amplifier offers cost advantages and a higher gain without sacrificing other performance characteristics.

### FIELD OF INVENTION

The present invention relates to optical amplifiers, and more particularly to an optical amplifier using an optical circulator and optical signal reflecting surface with an optical channel waveguide.

### BACKGROUND OF INVENTION

The field of optical telecommunications has experienced phenomenal growth over the past several years, fueled in large part by the development and deployment of erbium-doped fiber amplifiers (“EDFAs”) which are capable of amplifying multiple wavelengths independently in a single unit.

The deployment of EDFAs has traditionally been used in long distance or long-haul communication systems. In the long-haul market, optical amplifiers were designed for optimum performance and increased cost was tolerated and acceptable when traded off for desired operating characteristics. These networks were typically designed for point-to-point transmission, which limits the number of amplifiers required.

The continuing growth of EDFAs has led to a new demand in developing metropolitan and local access networks. The network architecture in the metropolitan and local markets vary but generally are considered to be ring, mesh or branched in topology. Thus, the number of nodes and access points is significantly higher than in the long-haul networks, requiring a large increase in the number of amplifiers required in these networks. In addition, the signal traffic tends to be much more dynamic in a metropolitan or local access network, which requires a more functional network design. However, increased functionality translates into a higher component count, which results in higher component transmission losses. Thus, because of both distance and component transmission losses, the number of amplifiers needed in the network architecture is increased as well as cost. Since the amplifier is used to make up for component losses or short distance transmission losses, high performance designs are not needed. Instead, the lower performance requirements coupled with the larger need causes network designers to gladly trade-off performance characteristics for cost. However, the ideal solution is to obtain all desired performance at the lowest possible cost.

Several devices have been developed to address this growing market segment. One such device is an EDFA in which the number of components has been reduced to the bare minimum and the pump laser diode is de-rated. However, even though the cost of the device may be reduced, the saturated output power and the noise figure are sacrificed.

Another attempted device uses a single-mode erbium-doped waveguide amplifier (EDWA) in which the traditional erbium-doped fiber in an EDFA is replaced by a waveguide. This design achieves cost savings by integrating components, such as a pump multiplexer, onto the waveguide chip. However, this device still uses a standard single-mode pump laser diode, which is the most costly component and sacrifices performance in gain, saturated output power and noise figure.

Another attempted device is a semiconductor optical amplifier (SOA) which uses the physical process of electron-hole recombination, driven by current injection, to amplify signals. Since this device is based on somewhat standard semiconductor processes in which large numbers of devices can be fabricated simultaneously, it is intrinsically low cost. However, the physics involved in amplifying signals this way have some fundamental differences from the other erbium-based techniques that result in severe noise figure problems and, in some cases, signal cross-talk between different wavelengths amplified in the same device.

### SUMMARY OF THE INVENTION

The shortcomings of the prior approaches are overcome, and additional advantages are provided, by the present invention which in one aspect is an optical waveguide amplifier having a circulator and an optical signal reflector which enable an optical signal to be exposed to double the amplification by traveling through a single channel waveguide twice.

In one embodiment, the optical amplifier includes a waveguide comprising a linear core having a first end for receiving an input optical signal and a second end. The waveguide may be optically configured to amplify the input optical signal using an optical pump signal applied thereto thereby producing an amplified optical signal. The optical amplifier further comprises an optical pump source for generating the optical pump signal. A reflective surface is disposed at the second end of the waveguide. The reflective surface is adapted to reflect input optical signals back through the linear core towards the first end of said waveguide. The amplifier further comprises a means for receiving the amplified signal exiting the first end of the waveguide.

To summarize, an optical signal enters the first end of the waveguide, travels through its linear core towards the second end, reflects off the reflective surface located at the second end which directs the optical signal back through the linear core towards the first end. The use of a circulator, splitter or other means manages the input optical signals to the waveguide and amplified signal from the waveguide. Since the optical signal travels along the core of the waveguide twice while being exposed to the pump energy, the optical signal is subjected to double the gain than if the optical signal would have exited the second end of the waveguide. Instead, the optical signal is reflected back into the linear core towards the first end of the waveguide as required by the amplifier made in accordance with the principles of the present invention.

In one embodiment, the pump energy is applied from the side of the waveguide. In an alternate embodiment, the pump energy is applied through the reflective surface at the second end of the waveguide.

The amplifier disclosed herein provides approximately twice the gain without sacrificing other performance characteristics as compared to, for example, two identical waveguides placed in series with each other where the optical signal enters one end and exits the opposite end of the waveguides. This invention provides a low-cost, compact package that can minimize the space required within, for example, a communications system to provide signal amplification.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following detailed description of the preferred embodiments (s) and the accompanying drawings in which:

FIG. 1 is a top view of one embodiment of an optical amplifier in accordance with the present invention, partially in schematic form and with a side pumped waveguide configuration and a circulator positioned within the amplifier housing;

FIG. 2 is a top view of another embodiment of an optical amplifier in accordance with the present invention, partially in schematic form and with an end pumped waveguide configuration and a circulator positioned within the amplifier housing; and

FIG. 3 is a top view of one embodiment of an optical amplifier in accordance with the present invention, partially in schematic form and with a side pumped waveguide configuration and a circulator as separate from the amplifier housing.

### DETAILED DESCRIPTION OF EMBODIMENTS OF THE INVENTION

Generally stated, a novel waveguide amplifier employing a circulator and an optical signal reflecting surface is presented wherein stimulated emission is employed in a waveguide to amplify signals in a fiber-optic system. To summarize, the unique amplifier architecture allows for an optical signal to pass along the length of a waveguide a first time, reflect off an optical signal reflecting surface and then pass along the length of the waveguide a second time by using a circulator, splitter or other means positioned near an input end of the waveguide to receive the amplified signal exiting the input end of the waveguide. The optical amplifier made in accordance with the principles of the present invention results in a higher gain by subjecting the optical signal to twice the pump energy and twice the length of a waveguide at a lower cost without sacrificing other performance characteristics.

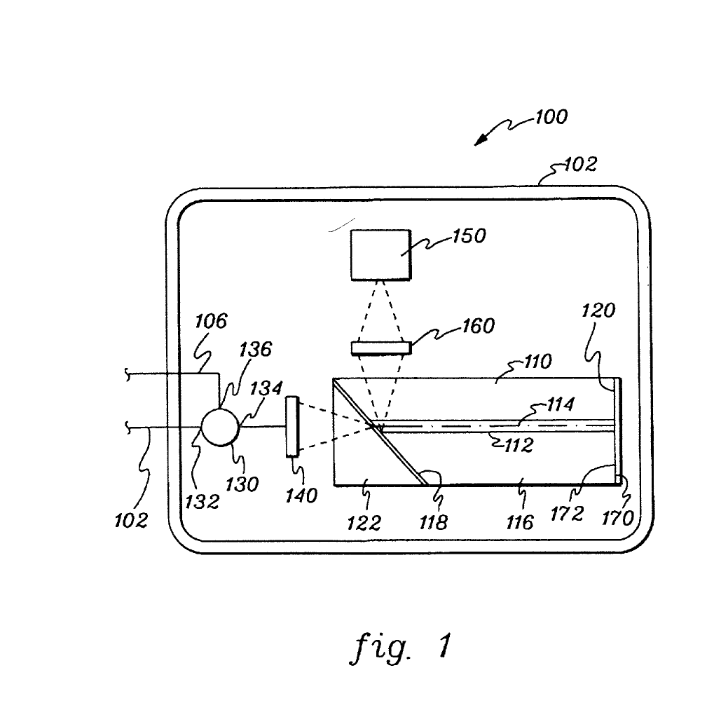

FIG. 1 depicts one embodiment of a waveguide amplifier 100 in accordance with the principles of the present invention. The waveguide amplifier 100 may be constructed employing a waveguide 110, a circulator 130 for separating input and output signals, signal coupling optics 140 to direct the input signal to the waveguide 110 and to direct the amplified signal from the waveguide 110 back to circulator 130, a pump laser 150, pump coupling optics 160 to couple the optical pump signal between pump laser 150 and waveguide 110, and an optical signal reflecting surface 170 for reflecting the input signal back into the waveguide at a second end 120 opposite input end 118 of waveguide 110.

In the illustrated embodiment shown in FIG. 1, optical waveguide 110 is in the form of a channel waveguide and positioned within housing 102 of amplifier 100. The waveguide 110 may be composed of a linear core 112 having a propagation axis 114 which may be longitudinally aligned with the outer surfaces of the waveguide 110. Core 112 may be nominally square in cross-section and of size from 10 micrometers to 30 micrometers on a side. Core 112 may be doped with an active ion such as ND or Er, among others, and composed of many materials such as YAG or glass, among others. The active material of waveguide core 112 can be optically pumped at one wavelength and consequently emit, and thereby amplify, light at a desired wavelength. The compact nature of waveguide 110 is enabled by the use of high-gain materials. Of particular applicability is the family of Erbium/Ytterbium (Er/Yb) co-doped phosphate glasses which have nearly 100 times the number density of atoms, do not suffer quenching effects, and have twice the emission cross-section relative to their silica counterparts typically used in EDFAs. The surrounding cladding 116 may be an undoped material of lower refractive index.

Exemplary waveguide may be of the type disclosed in U.S. Pat. No. 6,236,793 entitled “Optical Channel Waveguide Amplifier,” and may be fabricated using the procedures disclosed in U.S. Pat. No. 6,270,604 entitled “Method For Fabricating An Optical Waveguide” and U.S. Pat. No. 6,208,456 entitled “Compact Optical Amplifier With Integrated Optical Waveguide And Pump Source,” which are hereby incorporated herein by reference.

In one embodiment, an input end 118 of waveguide 110 is polished at a non-orthogonal angle, such as, for example, 45-degree angle, to propagation axis 114 of core 112, while opposing end 120 of the waveguide 110 may be polished normal to waveguide core 112. The angle-polished input end may then be coated to reflect an applied pump signal, and overlaid with a prism 122 matched in index of refraction to core 112 (and bonded to the waveguide with an ultraviolet (UV)-cured optical adhesive) for directing the input optical signal co-linearly into core 112 as signal.

Prism 122 also minimizes beam deviations and reflections for the transmitted signal beam. Prism 122 serves to provide a small distance between input end 118 of waveguide 110 and the nearest normal-incidence reflecting surface. Over this small distance, the beam travels in free-space, or unguided, which allows it to disperse slightly before hitting the normal-incidence reflecting surface.

At the interface between the prism and waveguide a negligible reflection is generated because the two materials making up the prism and waveguide core are approximately index matched. This provides an added protection that any small reflections at the interface between the waveguide and the prism are directed out of the waveguide. As an example of the utility of this design, assume a signal beam exits a 15 micrometer by 15 micrometer waveguide. At the interface between prism 112 and waveguide 110 a negligible reflection is generated because the two materials, waveguide core 112 and prism 122 are approximately index matched. Exiting the waveguide, the beam enters prism 122 in which it diverges with an angle of at least ten degrees full-width at half maximum. After traveling over a small distance such as, for example, 500 micrometers, the beam hits an AR-coated normal incidence surface 172, which generates a 0.25 percent reflection. This beam then propagates over the core distance a second time before arriving at the entrance 118 to the waveguide. Having propagated over twice the substrate thickness, the beam has diverged to nearly 190 micrometers. At this size, using just the ratio of areas, less than eight percent of the returning beam couples into the waveguide. The free-space diffraction combined with the AR-coating results in a maximum reflection of 0.02 percent or negative 37 dB, as compared to the 0.25% or negative 26 dB of an AR-coating directly on the waveguide facet.

Waveguide 110 requires a pump source 150 to provide a source of the optical pump signal for waveguide gain. Exemplary pump source disclosed herein is a single or multi-mode laser diode on a submount and maintained at constant temperature with a thermoelectric cooler. One exemplary diode is an Open Heat Sink Packaged Laser Diode available from High Power Devices, Inc., model number HPD1005C. Power is provided to both the laser diode and the TEC through external pins. Additional pins may also be included to incorporate a monitor photo diode to monitor pump laser power, a thermistor to monitor pump laser temperature, and gain monitoring sensors.

Pump 150 may be delivered to waveguide core 110 in one of two ways. The first design (illustrated in FIG. 1) couples the pump signal from the pump laser diode into waveguide 110 from the side. In this side pump configuration, pump source 150 is arranged to transmit the optical pump at an angle of 90 degrees relative longitudinal axis 114 of waveguide core 112. To couple the signal from the pump laser diode into the waveguide 110, lenses or optics 160 may be used to focus the pump into waveguide 110 off the 45 degree coated end-face 118 of waveguide 110. Pump delivery optics 160 may also have a focal length which is long enough to place the beam waist at the input to waveguide 110. Furthermore, it must re-focus the beam to a size that maximizes pump coupling efficiency.

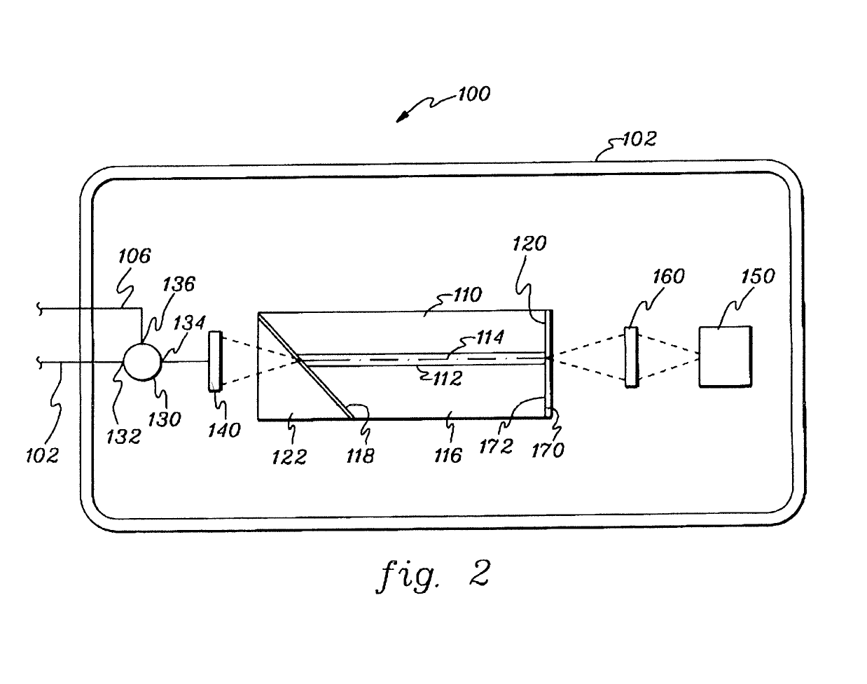

The second design option (illustrated in FIG. 2) couples the pump signal from the pump laser diode into the waveguide 110 through second end 120 of waveguide 110. In this design, pump source 150 is arranged to transmit the optical pump along longitudinal axis 114 of waveguide 110.

Pump optics 160 are designed for optimum coupling, and depend critically on the type of diode and waveguide used. For example, using a 15 micrometer by 15 micrometer waveguide with a 0.4 NA, a multi-mode diode (1 micrometer by 100 micrometer emitter) can be used and coupled to many or all of the modes of the waveguide. This achieves maximum power coupling for highest gain. The optical design in this case, involves one or more lenses designed to reduce the size of the beam to approximately 10 to 25 micrometers and increase the NA to 0.4 or greater.

In the embodiment in which the pump energy is introduced into waveguide 110 through the side (e.g. FIG. 1), opposing or second end 120 is configured to reflect both the pump and signal wavelengths. In one such embodiment, a mirror 170 such as, for example, a dielectric mirror (e.g. comprising a dielectric material) or metallic mirror, is attached to second end 120 of the waveguide and used to reflect both the pump and signal wavelengths.

In the embodiment in which the pump energy is introduced into waveguide 110 through an end (e.g. FIG. 2), opposing or second end 120 of waveguide 110 is configured to reflect light at the signal wavelength and pass light at the pump wavelength. This allows pump light to be input into the waveguide by directly focusing into waveguide core 112 through opposing end 120, while the optical signal is reflected off the inner surface 172 at opposing end 120 back towards input end 118. In one embodiment, the surface of second end 120 of waveguide 110 may be coated to reflect at the signal wavelength (and may be coated anti-reflective at the pump wavelength). In an alternate embodiment, a dielectric mirror 170 is attached to second end 120 of the waveguide which allows pump light to be input into waveguide 110 while reflecting the optical signal being amplified back into waveguide core 114.

As shown in FIGS. 1 and 2, amplifier also includes a multi-port fiber circulator 130 for separating input and output signals. Circulator 130 may be a passive device consisting of 3-ports that allows the signal entering each port to pass to the port adjacent to it (either clockwise or counter-clockwise) but not to the port in the other direction (e.g. available from New Focus, Inc. of San Jose, Calif., model number CIRIOAN32N-00). Circulator 130 comprises a first port 132 for receiving an optical signal from, for example, a single-mode optical fiber 102, a second port 134 to direct the input signal received through first port 132 out of circulator 130 and into signal optics 140 towards waveguide 110 and to accept the output or amplified signal received through second port 134 of waveguide 110 from signal optics 140, and a third port 136 for outputting the amplified signal out of the circulator 130 to, for example, a single-mode optical fiber 106. Circulator 130 differentiates the input and output signals by directing light input in one direction only, such as, for example, into first port 132 and out second port 134 and amplified light input into second port 134 and out third port 136.

In an alternate embodiment, a splitter or other means may be used in place of a circulator to deliver the optical signal to the waveguide and receive the amplified signal exiting the waveguide. However, a splitter may cause a greater loss and less isolation than a circulator.

The optical signal is delivered from, for example, a single-mode optical fiber 102, through circulator 130 (e.g. in first port 132 and out second port 134) to waveguide core 112 (through prism 122) using an appropriate set of signal delivery optics 140. Signal delivery optics 140 accept the optical beam expanding out of, for example, a single-mode optical fiber 104 in communication with second port 134 of circulator 130 and re-focus the beam to converge within the optical waveguide core 112. The overall optical assembly must have a working distance long enough to focus through the prism 122 and provide a minimum beam waist at the input to the waveguide core 112. Furthermore, it must re-focus the beam to a size that can fit within the waveguide dimensions for maximum signal coupling efficiency. The signal delivery optics 140 are designed to couple to and from the fundamental mode with little or no coupling to higher order modes. As an example, for a 15 micrometer by 15 micrometer waveguide with a numerical aperture (NA) of 0.4, the optics are designed to produce a beam of approximately 14 micrometers in diameter with a NA of 0.075.

In the past, the signal was delivered into the waveguide through prism and the input end of the waveguide using an appropriate set of signal delivery optics and then, after being amplified as it travels within the waveguide along the propagation axis, out the second end of the waveguide using a second set of optics for recovering the amplified signal. The amplified signal would then be recovered from the waveguide and placed back into, for example a single-mode optical fiber positioned at the second end of the waveguide. The signal entering the input end of the waveguide would only pass through the waveguide once and then exit though the second end. Thus, the signal was only amplified or pumped for the length of a single waveguide.

In the waveguide using a reflective surface 172 constructed in accordance with the principles of the present invention, the optical signal reflects off reflective surface 172 at second end 120 of waveguide 110 and is directed back through the waveguide core 112 a second time towards the first or input end 118 of waveguide 110. Signal delivery optics 140 positioned before input end 118 of the waveguide couple the amplified signal from waveguide 110 to optical fiber 104 for delivery to second port 134 of circulator 130. In other words, the same signal delivery optics 140 deliver signals into and out of the waveguide 110. At a minimum, a low numerical aperture (NA) matched pair of lenses may be used to image the signals with a 1:1 magnification ratio. Other options include lenses that can expand the beam to fill the waveguide core 112. In any case, the goal of optics 140 is to couple the signal light from circulator 130 into waveguide 110 and from waveguide 110 to circulator 130 with as little loss as possible.

In one embodiment of the present invention employing a waveguide and circulator 130 in accordance with the principles of the present invention, the signal to be amplified is delivered from optical fiber 102 into first port 132 of circulator 130. Next, the signal exits second port 134 of circulator 130, travels through optical fiber 104 and is accepted by the set of optics 140 which refocuses the signal to converge within the optical waveguide 110 through the prism 122 and input end 118. The waveguide 110 amplifies the injected signal as it travels along the propagation axis 114 of waveguide core 112 by the pump beam delivered from either the side (e.g. FIG. 1) or through second end 120 (e.g. FIG. 2). As the signal approaches second end 120 of the waveguide, the signal reflects off the dielectric mirror or reflective coating surface 172 back into waveguide core 112 to be further amplified. The amplified signal is recovered from the waveguide at first or input end 118 and placed back into optical fiber 104 using the same set of delivery optics 140 used to inject the original signal into waveguide core 112. Next, the amplified signal enters second port 134 of circulator 130 and exits third port 134 and placed into, for example, a single mode optical fiber 106.

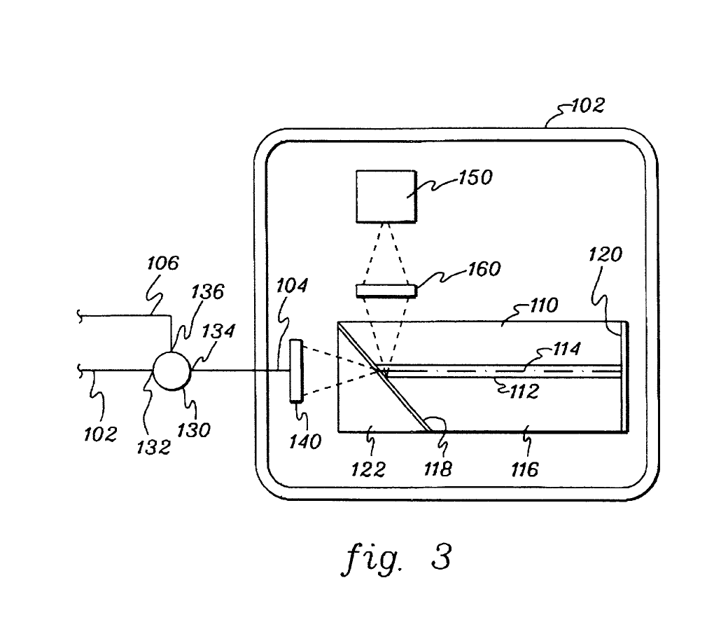

In alternate embodiments, circulator 130 can be packaged either internally (e.g. FIG. 1) or externally (e.g. FIG. 3) of housing 102 of the amplifier. Also, second port 134 of circulator 130 may include a lens with focusing characteristics identical to the set of signal coupling optics 140 such that the circulator and signal optics are combined as one component. This combined configuration and/or the packaging of circulator internally or externally of the housing of the amplifier may be employed in either a side pumped or end pumped waveguide configuration.

Since the signal passes through the same waveguide twice (e.g. double-pass configuration), the amplifiers discussed herein provide approximately the same gain (slightly higher or lower) as if two identical waveguides of the same length were placed in series. With the use of the circulator in accordance with the principles of the present invention, less components (e.g. additional sets of delivery optics, and pump and corresponding pump optics for a second waveguide) are required to achieve the same gain as two waveguides of the same length with an optical signal passing only once through each waveguide. Space is also conserved.

The amplifier made in accordance with the present invention may be powered by an external temperature controller and laser diode driver and may accept one or more signals on the input fiber and may deliver amplified signals on the output fiber.

The amplifiers discussed herein, based on a channel waveguide and three-port circulator, provide compact, low cost optical solutions for use in fiber optic systems. Their primary application is optical amplification in communication systems where space is at a premium, and smaller devices are required. In addition, these amplifiers are ideal for use in systems where the design requires large numbers of low-cost devices to achieve the desired performance. Finally, because of their compact nature, the amplifiers can be integrated with other devices such as splitters or multiplexers and de-multiplexers. When adding additional components into the package, the insertion loss associated with the components can be offset by the optical amplification, allowing for the development of “lossless” versions of these very same optical components.

The amplifiers discussed herein offer significant advantages over other devices designed to amplify signals while reducing costs. The device efficiently amplifies small signals traveling in optical fibers that have been attenuated due to long distance transmission or transmission through lossy components. The channel waveguide architecture enables the use of multi-component glasses (e.g. silicates and phosphates) that can accommodate extremely high dopant levels. In addition, the channel waveguide architecture also enables the use of multi-mode pump laser diodes which result in very high saturated output powers and extremely low cost. The optical assemblies that couple signals into and out of the waveguide also allow for the integration of additional components like filters. Integration of these components adds functionality in a way that minimizes additional cost. The complete amplifier may be packaged in a way that couples the light from the laser diode into the waveguide in free-space, thereby enabling the use of bare, unpackaged laser diodes, which are the lowest cost option.

In communications systems, this amplifier may be used to offset optical fiber transmission losses, losses accumulated by transmission through components, or to boost signal levels exiting lasers or entering receivers. In all cases, the gain, saturated output power and noise figure combine to determine where and how an amplifier may be used in a system with the goal of providing optimum signal transmission.

In the case of microwave links, delivery of the microwave signal depends largely on the power of the optical carrier. Thus, in these systems, amplifiers are used generally at the front end to boost the transmitter laser power prior to the modulator so maximum modulation depth can be achieved with the highest optical power. Amplifiers constructed in accordance with the principles of the present invention may also be used in microwave systems to offset transmission and component losses and to boost signals at the receiver, just as in communications systems.

As optional enhancements to the amplifier system made in accordance with the principles of the present invention, the AR coating on prisms 122 at the signal coupling end 118 of the waveguide can be combined with a coating that reflects the 975 nanometer light. This coating prevents pump light from entering the circulator and ultimately the output fiber and prohibits 975 nanometer light from transmitting down the fiber-optic system.

It may be desirable in some cases to provide gain that is flat versus wavelength. In this case, the reflective surface (e.g. mirror or coating) on the end of the waveguide that reflects the signal light for the double-pass can be designed to provide excess loss at wavelengths of higher gain resulting in a flattened gain spectrum. This gives the added benefit of not requiring a separate gain flattening filter and incorporating the filter directly into the package.

Also, the position of the reflective surface (e.g. mirror or coating) that reflects the signal light for the double-pass can be modified to minimize the noise figure of the amplifier. The noise figure of the amplifier is generally given by the ratio of the fluorescence, or amplified spontaneous emission (ASE), power to the gain at a given wavelength. In an embodiment in which the waveguide is multi-mode and is pumped by a multi-mode diode, the spontaneous emission occupies numerous mode of the waveguide even though the signal is in the fundamental mode. The spontaneous emission power that contributes to the noise figure then, is that which is coupled back into the fiber at the output of the device, which can consist of the power in several or even numerous modes. Since each mode diverges from the waveguide with different conical angles and the fundamental mode has the smallest angle, positioning the reflective surface some distance off of the waveguide facet can preferentially reflect light in the fundamental mode, thus reducing the overall ASE power and therefore the power that can be coupled back into the fiber more than reducing the gain.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. An optical amplifier, comprising:
a waveguide, said waveguide comprising a linear core having a first end for receiving an input optical signal and a second end, said waveguide optically configured to amplify the input optical signal using an optical pump signal applied thereto thereby producing an amplified optical signal;
an optical pump source for generating the optical pump signal;
a reflective surface disposed at the second end of said waveguide, said reflective surface adapted to reflect input optical signals back through the linear core and out the first end of said waveguide; and
means for receiving the amplified optical signal exiting the first end of said waveguide.

2. The optical amplifier of claim 1, wherein the optical pump signal is delivered through a side of said waveguide.

3. The optical amplifier of claim 1, wherein said waveguide comprises a surface through which the optical pump signal is received, wherein the surface is arranged at an approximately 45 degree angle with the linear core, and wherein the optical pump source transmits the optical pump signal at approximately a 90 degree angle with the core.

4. The optical amplifier of claim 1, wherein the optical pump signal is delivered through said reflective surface at the second end of said waveguide.

5. The optical amplifier of claim 1 further comprising a housing having optical signal input and outport ports.

6. The optical amplifier of claim 5, wherein said means for receiving the amplified optical signal is positioned either within or outside of said housing.

7. The optical amplifier of claim 1, wherein said mean for receiving the amplified optical signal is positioned near the first end of said waveguide.

8. The optical amplifier of claim 1, wherein said reflective surface is a dielectric mirror.

9. The optical amplifier of claim 1, wherein said reflective surface is a metallic mirror.

10. The optical amplifier of claim 1, wherein said means for receiving the amplified signal is a circulator.

11. The optical amplifier of claim 10, further comprising a set of coupling optics disposed between said circulator and the input end of said waveguide for transmitting the input optical signal into the linear core of said waveguide through the first end and for transmitting the amplified signal out of the linear core of said waveguide at the first end to said circulator.

12. The optical amplifier of claim 10, wherein said circulator comprises a first port for receiving input optical signals and a second port for outputting the input optical signals received from the first port and for receiving the amplified signal from said waveguide, and a third port for outputting the amplified signals received by the second port.

13. The optical amplifier of claim 12, wherein the second port of said circulator includes a set of optics for directing the input optical signal into the linear core of said waveguide and for directing the amplified signal out of the linear core of said waveguide to the second port of said circulator.

14. The optical amplifier of claim 1, wherein said waveguide further comprises a prism applied over the first end for directing the input optical signal co-linearly into the linear core and for directing the amplified signal co-linearly toward said means for receiving the amplified signal.

15. The optical amplifier of claim 14, wherein said prism is coated with a coating that reflects 975 nm pump light.

16. The optical amplifier of claim 1, wherein the optical pump source is a laser diode which generates the optical pump signal internal to said housing.

17. The optical amplifier of claim 1, wherein said waveguide is a channel waveguide.

18. The optical amplifier of claim 5, wherein said circulator receives the input optical signal from the input port of said housing when said circulator is positioned within said housing.

19. The optical amplifier of claim 5, wherein said circulator outputs the amplified signal to the output port of said housing when said circulator is positioned within said housing.

20. The optical amplifier of claim 1, wherein said reflective surface is spaced from the second end of said waveguide.

21. A method for optically amplifying an input optical signal, the method comprising:
providing a waveguide, the waveguide comprising a linear core having a first end for receiving the input optical signal and for outputting an amplified signal and a second end;
providing an optical pump signal to the waveguide to facilitate amplification of the input optical signal into the amplified optical signal as the input optical signal travels through the linear core;
positioning a reflective surface at the second end of the waveguide to reflect the input optical signal back through the linear core and out the first end of said waveguide; and
providing a means for receiving the amplified optical signal exiting the first end of the waveguide.

22. The method of claim 21, wherein the optical pump signal is provided through a side of the waveguide.

23. The method of claim 21, wherein the optical pump signal is provided through the reflective surface at the second end of the waveguide.

24. The method of claim 21, wherein the means for receiving the amplified signal is a circulator.

25. The method of claim 21, wherein the reflective surface is a mirror.

26. The method of claim 21 further comprising:
positioning a prism over the first end of the waveguide for directing the input optical signal co-linearly into the linear core and for directly the amplified signal co-linearly toward the means for receiving the amplified signal.

27. The method of claim 21 further comprising providing a housing.

28. The method of claim 27, wherein the waveguide is positioned within the housing.

29. The method of claim 27, wherein the means for receiving the amplified signal is positioned within the housing.

30. The method of claim 21 further comprising:
providing a set of coupling optics near the first end of the waveguide for transmitting the input optical signal into the linear core of the waveguide through the first end and for transmitting the amplified signal out of the linear core of the waveguide at the first end to the means for receiving the amplified signal.

31. A method for optically amplifying an input optical signal, the method comprising:
applying the input optical signal to a waveguide, the waveguide comprising a linear core having a first end for receiving the input optical signal and for outputting an amplified signal and a second end;
generating an optical pump signal;
applying the optical pump signal to the waveguide to facilitate amplification of the input optical signal into the amplified optical signal as the input optical signal travels through the linear core;
reflecting the input optical signal at the second end of the waveguide back through the linear core towards the first end of said waveguide; and
receiving the amplified optical signal exiting the first end of the waveguide.

32. The method of claim 31, wherein the optical pump signal is applied through a side of said waveguide.

33. The method of claim 31, wherein the optical pump signal is applied through the second end of said waveguide.

34. The method of claim 31, wherein a mirror reflects the optical signal at the second end.

35. The method of claim 31, further comprising:
transmitting the input optical signal into the linear core of said waveguide through a set of coupling optics.

36. The method of claim 31, wherein a circulator receives the amplified signal exiting the first end of the waveguide.

37. The method of claim 36, further comprising:
inputting the input optical signal into a first port of said circulator;
outputting the input optical signal inputted into the first port out a second port of said circulator towards the first end of said waveguide;
inputting the amplified signal exiting the first end of said waveguide into the second port of said circulator; and
outputting the amplified signal inputted into the second port out a third port of said circulator.

38. The method of claim 31, wherein the optical pump source is a laser diode which generates the optical pump signal internal to said housing.

39. The method of claim 31, wherein said waveguide is a channel waveguide.
